(19) United States
(12) Patent Application Publication
(10) Pub. No.: US 2021/0372679 A1
(43) Pub. Date: Dec. 2, 2021

(54) HEAT PUMP HAVING IMPROVED EFFICIENCY

(71) Applicant: Dong Won LEE, Gyeonggi-do (KR)

(72) Inventor: Dong Won LEE, Gyeonggi-do (KR)

(21) Appl. No.: 17/286,654

(22) PCT Filed: Oct. 7, 2019
(86) PCT No.: PCT/KR2019/013145

§ 371 Date: Apr. 19, 2021

(30) Foreign Application Priority Data
Nov. 15, 2018 (KR) 10-2018-0141188
Nov. 19, 2018 (KR) 10-2018-0142871
Apr. 13, 2019 (KR) 10-2019-0043404
May 16, 2019 (KR) 10-2019-0057587
Aug. 4, 2019 (KR) 10-2019-0094645

(51) Int. Cl. F25B 49/02; F25B 30/02; F25B 43/00

(52) U.S. Cl. CPC F25B 49/025; F25B 30/02; F25B 2600/112; F25B 2500/19; F25B 2600/111; F25B 43/006

(57) ABSTRACT

A heat pump configured by connecting a circuit including a variable capacity compressor, a condenser, an expansion valve, and an evaporator through a closed refrigerant line, includes a condenser fan, an evaporator fan, a refrigerant amount adjusting means for charging or recovering a refrigerant in or from the circuit, and a controller. Roles of the controller include setting a target pressure inside an outdoor heat exchanger y referring to an outside temperature and a load, setting a target pressure inside an indoor heat exchanger by referring to an inside temperature and a set temperature, setting a target sub-cooling degree and a target super-heating degree, and controlling both of the fans to either adjust temperature or adjust pressure.

### BACKGROUND

The present invention relates to a heat pump having improved efficiency.

A heat pump is a device that transfers heat from a heat source to a destination called “heater sink”. The heat pump absorbs heat from a cold space and dissipates heat into a warm space. Representative examples of the heat pump are a refrigerator and an HVAC (Heating Ventilating and Air Conditioning) device such as an air conditioner. In addition, devices using the heat pump are a water purifier providing cold/hot water, a dryer, a washing machine, a vending machine, and the like.

The heat pump is composed of a compressor, a condenser, an expansion valve, and an evaporator. In general, it is known that an air conditioner consumes about 20 times more electricity than an electric fan. Based on this calculation, the compressor consumes 90% electricity, and each of a condenser fan and an evaporator fan consume 5% electricity.

In order to reduce the power consumption of the compressor, an inverter compressor that operates at a low frequency under a small load has been used. If a difference between an inlet pressure and an outlet pressure of the compressor increases, the compressor consumes more electricity even operating at the same frequency. In case of the cooling seasonal performance factor (CSPF) and the integrated energy efficiency radio (IEER) which are measured under multiple load conditions, the heat pump efficiency is improved when a target low pressure and a target high pressure are actively achieved. However, a conventional a conventional heat pump has a problem of low efficiency because it is not controlled by setting the inlet pressure and the outlet pressure of the compressor as the first-priority achievement goal.

In US 2009/00137001 and application number KR 10-2016-0072934, the target pressure (low pressure) is achieved with the compressor having large power consumption, so that there is a problem of great fluctuation in power consumption.

### Prior Patent Documents

Application No. KR 10-2007-7009952 (US 2009/0013700 A1)

Application No. KR 10-2016-0072934

Application No. KR 10-2013-0084665 (US 2015/0020536 A1)

Application No. KR 10-2016-7026740 (US 2016/0370044 A1)

Application No. 10-2007-0084960

US 2011/0041523 A1

U.S. Pat. No. 7,010,927 B2

U.S. Pat. No. 9,738,138 B2

U.S. 2017/0059219 A1

US 2017/0115043 A1

### Prior Non-Patent Documents

Myung Sup Yoon, Jae Hun Lim, Turki Salem M A L Qahtani, and YujinNam, “Experimental study on comparison of energy consumption between constant and variable speed air-conditioners in two different climates”, Asian Conference on Refrigeration and Air-conditioning June 2018, Sapporo, JAPAN

### SUMMARY OF THE INVENTION

It is intended to set a target high pressure and a target low pressure under each load condition, in a heat pump whose efficiency is measured under multiple load conditions, and achieve the target pressures most preferentially. In addition, it is intended to provide a heat pump having improved efficiency by avoiding achieving the target pressures by a compressor having high electricity consumption.

### Technical Solution

A heat pump according to the present invention is configured by connecting a circuit including a variable capacity compressor (C), a condenser (HEX_C), an expansion valve (EXV), and an evaporator (HEX_E) through a closed refrigerant line, and comprises a condenser fan (FN_C), an evaporator fan (FN_E), a refrigerant (charging) amount adjusting means (RAAM) for charging or recovering a refrigerant in or from the circuit, and a controller 224, wherein roles of the controller 224 include 1) setting a target pressure inside an outdoor heat exchanger (HEX_EX) by referring to an outside temperature and a load, 2) setting a target pressure inside an indoor heat exchanger (HEX_IN) by referring to an inside temperature and a set temperature, 3) setting a target sub-cooling degree (SC_t) and a target super-heating degree (SH_t), 4) controlling both of the fans to either adjust temperature or adjust pressure, 4a) in case that both of the fans adjust temperature, adjusting a super-heating degree (SC) with the evaporator fan (FN_E), adjusting a sub-cooling degree (SH) with the condenser fan (FN_C), adjusting a high pressure (HP) with one of the expansion valve (EXV) and the refrigerant amount adjusting means (RAAM), and adjusting a low pressure (LP) with other one [cases (a) and (a′)], 4b) in case that both of the fans adjust pressure, adjusting a high pressure (HP) with the condenser fan (FN_C), adjusting a low pressure (LP) with the evaporator fan (FN_E), adjusting a super-heating degree (SC) with one of the expansion valve (EXV) and the refrigerant amount adjusting means (RAAM), and adjusting a sub-cooling degree (SH) with other one [cases (b) and (b′)], and 5) controlling the compressor (C) so that a predetermined refrigerant per unit time (gram/sec) is compressed with reference to load. If the load changes gradually as time elapses from 0 o'clock to 24 o'clock, power consumed by the heat pump gradually changes into a form similar to the load.

A heat pump according to the present invention is configured by connecting a circuit including a variable capacity compressor (C), a condenser (HEX_C), an expansion valve (EXV), and an evaporator (HEX_E) through a closed refrigerant line, and comprises a condenser fan (FN_C), an evaporator fan (FN_E), a refrigerant (charging) amount adjusting means (RAAM) for charging or recovering a refrigerant in or from the circuit, and a controller 224, wherein roles of the controller 224 include 1) setting a target pressure inside an outdoor heat exchanger (HEX_EX) by referring to an outside temperature and a load, 2) setting a target pressure inside an indoor heat exchanger (HEX_IN) by referring to an inside temperature and a set temperature, 3) setting a target sub-cooling degree (SC_t) and a target super-heating degree (SH_t), 4) controlling one of the two fans to adjust pressure and controlling other one to adjust temperature, 4a) in case of adjusting a low pressure (LP) with the evaporator fan (FN_E), adjusting a sub-cooling degree (SC) with the condenser fan (FN_C), adjusting a high pressure (HP) with one of the expansion valve (EXV) and the refrigerant (charging) amount adjusting means (RAAM), and adjusting a super-heating degree (SH) with other one [cases (d) and (d′)], 4b) in case of adjusting a high pressure (HP) with the condenser fan (FN_C), adjusting a super-heating degree (SH) with the evaporator fan (FN_E), adjusting a low pressure (LP) with one of the expansion valve (EXV) and the refrigerant (charging) amount adjusting means (RAAM), and adjusting a sub-cooling degree (SC) with other one [cases (e) and (e′)], and 5) controlling the compressor (C) so that a predetermined refrigerant per unit time (gram/sec) is compressed with reference to load. If the load changes gradually as time elapses from 0 o′clock to 24 o′clock, power consumed by the heat pump gradually changes into a form similar to the load.

In the heat pump, the refrigerant (charging) amount adjusting means (RAAM) may include a refrigerant storage space (RS) for storing refrigerant, a recovery valve (vvd) for recovering the refrigerant from the circuit to the refrigerant storage space (RS), and a charging valve (vvc) for charging the refrigerant from the refrigerant storage space (RS) to the circuit; the refrigerant charge recovery means (RCRM) may be installed in parallel with the expansion valve (EXV); the recovery valve (vvd) may be connected to an outlet of the condenser (HEX_C); and the charging valve (vvc) may be connected to a low pressure.

In addition, the controller 224 may perform control of simultaneously increasing or decreasing opening degrees of the recovery valve (vvd) and the charging valve (vvc) so that the refrigerant (charging) amount adjusting means (RAAM) performs a role of the expansion valve (EXV).

A heat pump according to the present invention is configured by connecting a circuit including a variable capacity compressor (C), a condenser (HEX_C), an expansion valve (EXV), and an evaporator (HEX_E) through a closed refrigerant line, and comprises a condenser fan (FN_C), an evaporator fan (FN_E), a refrigerant (charging) amount adjusting means (RAAM) for charging or recovering a refrigerant in or from the circuit, and a controller 224, wherein the controller 224 uses a target condensation temperature (HP_t) and a target evaporation temperature (LP_t) corrected by a curve in a temperature range for calculating a cooling seasonal performance factor (hereinafter, “CSPF”); the curve is shown at a lower outside temperature in a coefficient of performance table in the form of FIG. 12; and on a right side of a straight line connecting a first point (a target evaporation temperature at the maximum outside air temperature used in CSPF calculation) and a second point (a target evaporation temperature at the minimum outside air temperature used in the CSPF calculation) in the table, the curve (“evaporation temperature curve correction for lower outside air”) appears.

According to a heat pump control method of the present invention, in a heat pump whose efficiency is measured under a plurality of load conditions, the heat pump is provided so as to set a target high pressure and a target low pressure under each load condition and also achieve the target pressures most preferentially. In addition, there is an effect of providing a heat pump having improved efficiency by avoiding achieving the target pressures by a compressor having high electricity consumption.

### DESCRIPTION OF DRAWINGS

FIG. 1 is an example of a conventional p-h diagram.

FIG. 2 is a diagram for helping understanding of the first control to the fourth control of the present invention.

FIG. 3 is an example of a p-h diagram according to the present invention.

FIG. 4 is an example of a control procedure of the present invention.

FIG. 5 is an example of enumerating types of a control procedure of the present invention.

FIG. 6 is an example of a heat pump circuit adapted for the present invention.

FIG. 7 is another example of a heat pump circuit adapted for the present invention.

FIG. 8 is still another example of a heat pump circuit adapted for the present invention.

FIG. 9 is yet another example of a heat pump circuit adapted for the present invention.

FIG. 10 is a table showing the roles of main components adapted for the present invention.

FIG. 11 is an example of calculating CSPF preferred in the present invention.

FIG. 12 is another example of calculating CSPF preferred in the present invention.

### DESCRIPTION OF THE INVENTION

Hereinafter, preferred embodiments of the present invention will be described in detail with reference to the accompanying drawings. In the drawings, the same elements are denoted by the same reference numerals. In the description, singular forms are intended to include plural forms as well, unless the context clearly indicates otherwise. The terms “comprise” and/or “comprising” denote the presence of stated elements, steps, and/or operations, but do not exclude the presence or addition of one or more other elements, steps, and/or operations.

In addition, terms or words used in the following description and claims should not be interpreted as being limited to conventional or dictionary meanings, but should be interpreted as meanings and concepts consistent with the technical idea of the present invention. Detailed descriptions of known configurations and functions that are determined to unnecessarily obscure the subject matter of the present invention will be omitted.

In the following description, an ideal heat pump is used for convenience unless otherwise specified. A controller controls components of the heat pump and adjusts the performance of each component. In the following description, a phrase such as “adjusting”, “controlling”, “controlled”, or the like, means, even if the controller is not separately mentioned, that “the controller provides a control value so that the operation of the phrase is performed”. In addition, the term “control” performed by the controller may refer to any “role” or any “sequence”. In this description, the term “control” should be interpreted as “role” unless otherwise noted. Also, in this description, the term “pressure” may be interpreted as “at that pressure, a temperature at which refrigerant boils, namely, a condensation temperature or an evaporation temperature”.

### Description of Main Concepts

A heat exchanger can calculate the amount of heat exchange as Q=c·m·dT. There are many combinations of ‘m’ and ‘dT’ that make Q equal. In the above formula, ‘m’ (e.g., when a heat exchange material is air) may be interpreted as the amount of air, an air weight, a wind speed, a heat exchanger fan speed, a fan power consumption, or the like. In addition, ‘c’ may be the air specific heat or a proportionality coefficient. A temperature difference ‘dT’ (i.e., an air temperature before passing through the heat exchanger minus an air temperature after passing through) may be changed by a difference between the temperature at which refrigerant boils inside the heat exchanger and the temperature of an incoming air. In the present invention, the control to reduce ‘dT’ may mean “control to reduce a difference between the temperature at which refrigerant boils in the heat exchanger and the temperature of a material (e.g., air) to be heat-exchanged with the heat exchanger”.

In more detail, if the heat exchanger temperature (the temperature at which refrigerant boils inside the heat exchanger) and the air temperature are equal to each other, heat exchange does not occur. Therefore, one of methods for reducing the temperature difference ‘dT’ is to reduce a difference between the temperature of air flowing into the heat exchanger and the temperature at which refrigerant boils inside the heat exchanger (hereinafter, referred to as “heat exchanger temperature”). To do this, it is required to adjust a pressure inside the heat exchanger.

In general, the power consumption of a compressor is much greater than that of a fan. Therefore, if the temperature difference ‘dT’ is greater than a predetermined value, it needs to increase ‘m’ and decrease ‘dT’ to achieve the target heat exchange amount (Q=c·m·dT). This can reduce the total power consumption and thereby improve the efficiency of the heat pump.

### Description of Elemental Technologies

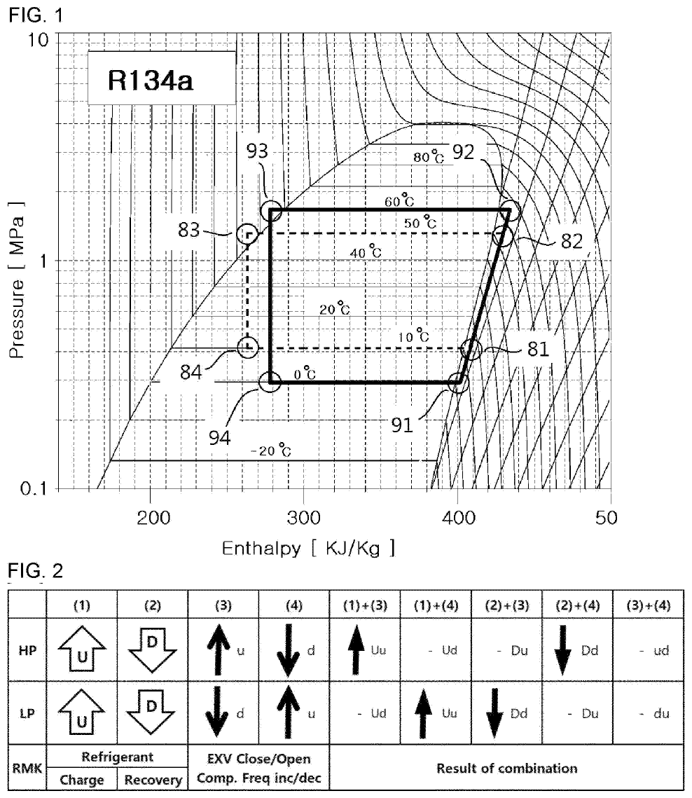

Hereinafter, it will be described with reference to FIGS. 1 and 2.

Injecting refrigerant into a heat pump system will be described. When a pipe of a heat pump is completely installed, the inside of the pipe is made vacuum with a vacuum pump. Then, an external (on an electronic scale) refrigerant container and a low pressure line are connected and a compressor is operated. When a valve of the external refrigerant container is opened, the refrigerant is charged from the external refrigerant container into the heat pump. When the refrigerant of a predetermined weight is charged, the valve of the external refrigerant container is closed. Then, high and low pressures are properly formed in the heat pump. For example, a first cooling cycle (81)-(82)-(83)-(84) is formed. Here, it can be seen that when the refrigerant is charged (hereinafter, “first control”), both the high pressure (HP) and the low pressure (LP) are increased (1) (from vacuum to low pressure, and from vacuum to high pressure). On the contrary, it can be seen that when the refrigerant is recovered (hereinafter, “second control”), both the high pressure (HP) and the low pressure (LP) are decreased (2) (from low pressure to vacuum, and from high pressure to vacuum).

In other words, if the refrigerant is additionally charged to the low pressure of a cooling circuit in which high and low pressures are properly formed, the added refrigerant is not all at a low pressure and partially moves to a high pressure (until the high and low pressures will be stabilized). Here, when the refrigerant is charged (i.e., when the first control is performed), both the high pressure (HP) and the low pressure (LP) are increased (1). In contrast, when the refrigerant is recovered (i.e., when the second control is performed), both the high pressure (HP) and the low pressure (LP) are decreased (2).

When the expansion valve is further closed (hereinafter, “third control” by which a difference between high and low pressures is increased) in a state that the first cooling cycle (81)-(82)-(83)-(84) is formed, the high pressure (HP) is increased and the low pressure (LP) is decreased (3). So, a second cooling cycle (91)-(92)-(93)-(94) can be formed. The third control can also be realized by driving the inverter compressor faster. In addition, when the expansion valve is further opened (hereinafter, “fourth control” by which the difference between high and low pressures is decreased) in a state that the second cooling cycle (91)-(92)-(93)-(94) is formed, the high pressure (HP) is decreased and the low pressure (LP) is increased (4). So, the first cooling cycle (81)-(82)-(83)-(84) can be formed. The fourth control can also be realized by driving the inverter compressor at a lower frequency. In this case, the expansion valve is preferably an electronic expansion valve (EEV).

When the first control (1) or the second control (2) is performed, both high and low pressures are increased (UU) or both are decreased (DD). When the third control (3) or the fourth control (4) is performed, the high pressure is increased (u) and the low pressure is decreased (d), or the high pressure is decreased (d) and the low pressure is increased (u). Combining a control by which both pressures move to one side and a control by which both move in the opposite directions can maintain one pressure and adjust the other pressure.

For example, if the first control (1) and the third control (3) are performed simultaneously or sequentially (regardless of the order) [(1)+(3)], the high pressure is increased and the low pressure cancels out and thereby may not fluctuate. In addition, if the first control (1) and the fourth control (4) are performed simultaneously or sequentially (regardless of the order) [(1)+(4)], the low pressure is increased and the high pressure cancels out and thereby may not fluctuate. In addition, if the second control (2) and the third control (3) are performed simultaneously or sequentially (regardless of the order) [(2)+(3)], the low pressure is decreased and the high pressure cancels out and thereby may not fluctuate. In addition, if the second control (2) and the fourth control (4) are performed simultaneously or sequentially (regardless of the order) [(2)+(4)], the high pressure is decreased and the low pressure cancels out and may not fluctuate. In such cases, it is preferable to control the condenser fan and the evaporator fan so that the degree of sub-cooling and the degree of super-heating become design values.

If the third control (3) and the fourth control (4) are performed simultaneously or sequentially (regardless of the order) [(3)+(4)], it is possible to control the amount of refrigerant circulation per unit time without changing the high and low pressures. Specifically, further increasing the difference between the high and low pressures by further increasing the amount of refrigerant compression per unit time of the compressor in the third control (3), and also further decreasing the difference between the high and low pressures by further opening the expansion valve in the fourth control (4) can further increase the amount of refrigerant circulating in the circuit per unit time (gram/sec, hereinafter “g/s”) even though the high and low pressures do not change. On the other hand, it is natural that the amount of refrigerant circulating in the circuit can be further reduced by changing a control target of the third control and the fourth control.

Hereinbefore, the elemental technologies required to control the pressure on the other side while maintaining the pressure on one side have been described. In this description, it should be noted that high pressure can be interpreted as “temperature at which the refrigerant boils at the high pressure”, that is, “condensation temperature”, and low pressure as “temperature at which the refrigerant boils at the low pressure”, that is, “evaporation temperature”.

### First Embodiment

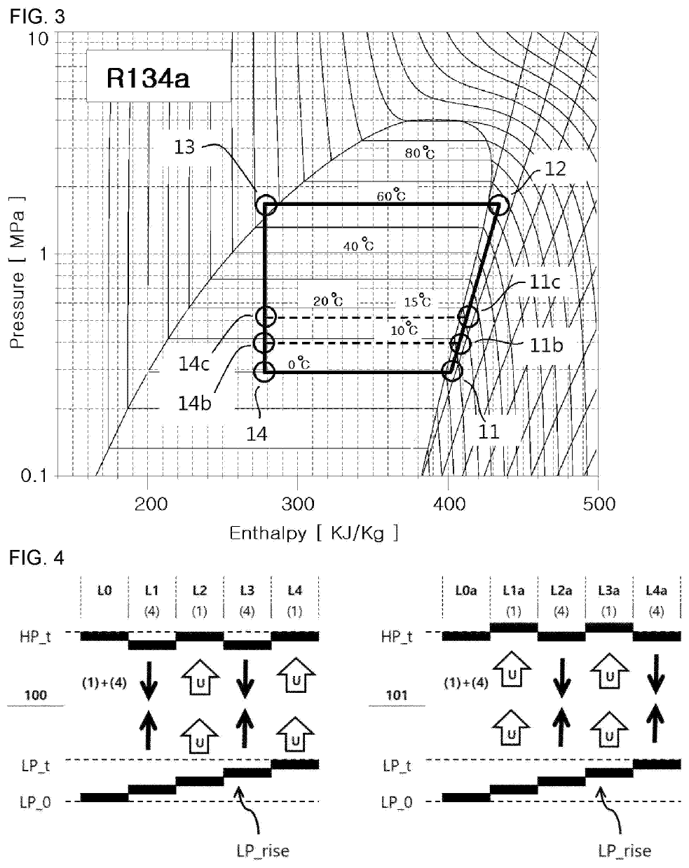

Now, an embodiment (air conditioner cooling mode) of controlling the evaporation temperature to be higher in the heat pump according to the present invention will be described with reference to FIGS. 2 to 4.

FIG. 4 shows examples of a procedure for controlling the evaporation temperature of the evaporator to be higher. A control procedure 100 is a case of sequentially performing the fourth control (4) and the first control (1) twice. In the initial state L0, the controller sets the target low pressure (LP_t) higher than the current low pressure (LP_0) according to certain necessity. Then, the low pressure is different from the target value, and the controller performs the fourth control (4) so as to make the low pressure equal to the target value. As a result, the low pressure rises, and the high pressure falls, so that a state L1 is obtained. The evaporation temperature becomes higher because the low pressure rises as desired, but the condensation temperature becomes lower than the target condensation temperature (HP_t) because the high pressure falls.

Then, when the controller performs the first control (1) so as to make the high pressure equal to the target value (HP_t), the refrigerant is charged and thereby both the high and low pressures rise. Thus, a state L2 is obtained. That is, the evaporation temperature of the low pressure further rises and is further closer to the target evaporation temperature (LP_t), and the high pressure maintains the target condensation temperature (HP_t). Meanwhile, a state L3 and a state L4 show results obtained by sequentially repeating the fourth control (4) and the first control (1) once more. Then, the low pressure rises along the LP rise to reach the target low pressure (LP_t).

Describing the control procedure 100 dmfdmfdmf from the viewpoint of the controller, in the initial state L0, the controller sets the target low pressure (LP_t) higher than the current low pressure (LP_0) according to certain necessity. The controller recognizes that the low pressure (LP_0) is lower than the target value (LP_t) in the initial state L0, and performs the fourth control (4) of further opening the expansion valve so as to make the low pressure equal to the target value (LP_t). As a result, the state L1 is obtained. In the state L1, the controller recognizes that the high pressure is lower than the target value, and performs the first control (1) of charging the refrigerant so as to make the high pressure equal to the target value (HP_t). In this example, it can be seen that the role of the controller is to achieve the target value by adjusting the expansion valve when the low pressure is out of the target value, and to achieve the target value by adjusting the refrigerant charge amount when the high pressure is out of the target value.

In FIG. 4, a control procedure 101 uses the fourth control (4) and the first control (1) as in the control procedure 100, but it is a case of performing the first control (1) first. In the initial state L0a, the controller sets the target low pressure (LP_t) higher than the current low pressure (LP_0) according to certain necessity. Then, the low pressure is different from the target value, and the controller performs the first control (1) so as to make the low pressure equal to the target value. As a result, the low pressure rises, and the high pressure falls, so that a state L1a is obtained. The evaporation temperature becomes higher because the low pressure rises as desired, but the condensation temperature becomes higher than the target condensation temperature (HP_t) because the high pressure falls. Then, when the controller performs the fourth control (4) so as to make the high pressure equal to the target value (HP_t), the high pressure falls, and the low pressure rises, so that a state L2a is obtained. That is, the evaporation temperature of the low pressure further rises and is further closer to the target evaporation temperature (LP_t), and the high pressure maintains the target condensation temperature (HP_t). Meanwhile, a state L3a and a state L4a show results obtained by sequentially repeating the first control (1) and the fourth control (4) once more. Then, the low pressure rises along the LP_rise to reach the target low pressure (LP_t).

Describing the control procedure 101 from the viewpoint of the controller, in the initial state L0a, the controller sets the target low pressure (LP_t) higher than the current low pressure (LP_0) according to certain necessity. The controller recognizes that the low pressure (LP_0) is lower than the target value (LP_t) in the initial state L0a, and performs the first control (1) of charging the refrigerant so as to make the low pressure equal to the target value (LP_t). As a result, the state Lla is obtained. In the state L1a, the controller recognizes that the high pressure is higher than the target value, and performs the fourth control (4) of further opening the expansion valve so as to make the high pressure equal to the target value (HP_t). In this example, it can be seen that the role of the controller is to achieve the target value by adjusting the expansion valve when the high pressure is out of the target value, and to achieve the target value by adjusting the refrigerant charge amount when the low pressure is out of the target value.

To summarize by comparing the control procedures 100 and 101, both set the target low pressure (LP_t) higher than the current value and achieve the target. In addition, both use the first control (1) and fourth control (4) together. However, the goals of the first and fourth controls are interchanged. The first control charges the refrigerant, but this is used on one side to achieve the target high pressure, and on the other side to achieve the target low pressure. In other words, the same result can be obtained by changing the order of the first control (1) and the fourth control (4). To do this, the goals of controls should be interchanged.

As shown in the control procedures 100 and 101, the same effect can be obtained even if the order of the first control (1) and the fourth control (4) is changed. Therefore, when interpreted in a broad sense, the control procedure 100 in the present invention includes the control procedure 101. Similarly, each of control procedures 150, 200, and 250 to be described below should also be interpreted in a broad sense.

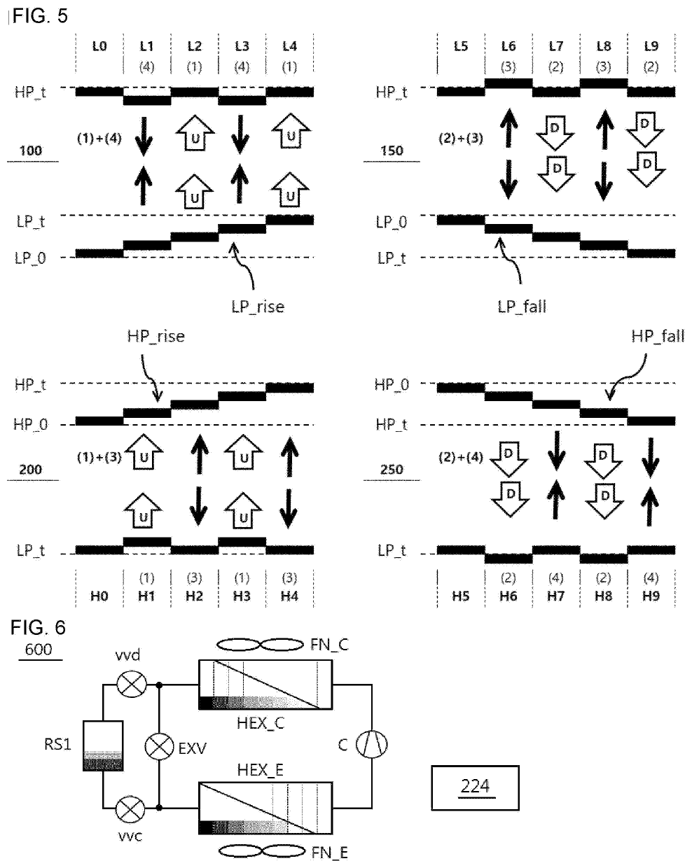

In FIG. 5, a control procedure 200 is a case of sequentially performing the first control (1) and the third control (3) twice. In the initial state H0, the controller sets the target high pressure (HP_t) higher than the current high pressure (HP_0) according to certain necessity. Then, the high pressure is different from the target value, and the controller performs the first control (1) so as to make the high pressure equal to the target value (HP_t). As a result, both the high and low pressures rise, so that a state H1 is obtained. The condensation temperature is further closer to the target condensation temperature (LP_t) because the high pressure rises as desired, but the evaporation temperature becomes higher than the target evaporation temperature (LP_t) because the low pressure also rises. Then, when the controller performs the third control (3) with the expansion valve so as to make the low pressure equal to the target value (LP_t), a difference between the high and low pressures becomes larger, the high pressure rises, the low pressure falls, and thereby a state H2 is obtained. That is, the condensation temperature of the high pressure further rises and is further closer to the target condensation temperature (HP_t), and the low pressure maintains the target evaporation temperature (LP_t). Meanwhile, a state H3 and a state H4 show results obtained by sequentially repeating the first control (1) and the third control (3) once more. Then, the high pressure rises along the HP rise to reach the target high pressure (HP_t).

Describing the control procedure 200 from the viewpoint of the controller, in the initial state H0, the controller sets the target high pressure (HP_t) higher than the current high pressure (HP_0) according to certain necessity. Then, the high pressure is different from the target value, and the controller performs the first control (1) of charging the refrigerant so as to make the high pressure equal to the target value (HP_t). As a result, the state H1 is obtained. In the state H1, the controller recognizes that the low pressure is higher than the target value, and performs the third control (3) of further closing the expansion valve so as to make the low pressure equal to the target value (LP_t). In this example, it can be seen that the role of the controller is to achieve the target value by adjusting the refrigerant charge amount when the high pressure is out of the target value, and to achieve the target value by adjusting the expansion valve when the low pressure is out of the target value. If the order of the first control (1) and the third control (3) is changed in the control procedure 200, it is natural that the controller should adjust the low pressure with the refrigerant charge amount and adjust the high pressure with the expansion valve.

In FIG. 5, a control procedure 150 is a case of sequentially performing the third control (3) and the second control (2) twice. In the initial state L5, the controller sets the target low pressure (LP_t) lower than the current low pressure (LP_0) according to certain necessity. Then, the low pressure is different from the target value, and the controller performs the third control (3) with the expansion valve so as to make the low pressure equal to the target value (LP_t). As a result, the high pressure rises, and the low pressure falls, so that a state L6 is obtained. The evaporation temperature becomes lower because the low pressure falls as desired, but the condensation temperature becomes higher than the target condensation temperature (HP_t) because the high pressure rises.

Then, when the controller performs the second control (2) so as to make the high pressure equal to the target value (HP_t), the refrigerant is recovered, both the high and low pressures fall, and thereby a state L7 is obtained. That is, the evaporation temperature of the low pressure further falls and is further closer to the target evaporation temperature (LP_t), and the high pressure maintains the target condensation temperature (HP_t). Meanwhile, a state L8 and a state L9 show results obtained by sequentially repeating the third control (3) and the second control (2) once more. Then, the low pressure falls along the LP_fall to reach the target low pressure (LP_t).

Describing the control procedure 150 from the viewpoint of the controller, in the initial state L5, the controller sets the target low pressure (LP_t) lower than the current low pressure (LP_0) according to certain necessity. The controller recognizes that the low pressure (LP_0) is higher than the target value (LP_t) in the initial state L5, and performs the third control (3) of further closing the expansion valve so as to make the low pressure equal to the target value (LP_t). As a result, the state L6 is obtained. In the state L6, the controller recognizes that the high pressure is higher than the target value, and performs the second control (2) of recovering the refrigerant so as to make the high pressure equal to the target value (HP_t). In this example, it can be seen that the role of the controller is to achieve the target value by adjusting the expansion valve when the low pressure is out of the target value, and to achieve the target value by adjusting the refrigerant charge amount when the high pressure is out of the target value. If the order of the second control (2) and the third control (3) is changed in the control procedure 150, it is natural that the controller should adjust the low pressure with the refrigerant charge amount and adjust the high pressure with the expansion valve.

In FIG. 5, a control procedure 250 is a case of sequentially performing the third control (3) and the second control (2) twice. In the initial state L5, the controller sets the target low pressure (LP_t) lower than the current low pressure (LP_0) according to certain necessity. Then, the high pressure is different from the target value, and the controller performs the second control (2) of recovering the refrigerant so as to make the high pressure equal to the target value (HP_t). As a result, both the high and low pressures fall, so that a state H6 is obtained. The condensation temperature is further closer to the target condensation temperature (HP_t) because the high pressure falls as desired, but the evaporation temperature becomes lower than the target evaporation temperature (LP_t) because the low pressure also falls. Then, when the controller performs the fourth control (4) so as to make the low pressure equal to the target value (LP_t), a difference between the high and low pressures becomes smaller, the high pressure falls, the low pressure rises, and thereby a state H7 is obtained. That is, the condensation temperature of the high pressure further falls and is further closer to the target condensation temperature (HP_t), and the low pressure maintains the target evaporation temperature (LP_t). Meanwhile, a state H8 and a state H9 show results obtained by sequentially repeating the second control (2) and the fourth control (4) once more. Then, the high pressure falls along the HP_fall to reach the target high pressure (HP_t).

Describing the control procedure 250 from the viewpoint of the controller, in the initial state H5, the controller sets the target high pressure (HP_t) lower than the current high pressure (HP_0) according to certain necessity. Then, the high pressure is different from the target value, and the controller performs the second control (2) of recovering the refrigerant so as to make the high pressure equal to the target value (HP_t). As a result, the state H6 is obtained. In the state H6, the controller recognizes that the low pressure is lower than the target value, and performs the fourth control (4) of further opening the expansion valve so as to make the low pressure equal to the target value (LP_t). In this example, it can be seen that the role of the controller is to achieve the target value by adjusting the expansion valve when the low pressure is out of the target value, and to achieve the target value by adjusting the refrigerant charge amount when the high pressure is out of the target value. In summary, the controller adjusts the low pressure with the expansion valve and adjusts the high pressure with the refrigerant charge amount. If the order of the second control (2) and the fourth control (4) is changed in the control procedure 250, it is natural that the controller should adjust the low pressure with the refrigerant charge amount and adjust the high pressure with the expansion valve.

When the conventional air conditioner is operated to some extent and the cooling load is reduced (i.e., the heat exchange requirement is reduced) (or when the load is reduced due to a lower outside temperature), the outdoor unit fan (FN_EX) rotates below the maximum speed. In this case, if the heat exchange temperature difference in the condenser is large, it is preferable to lower the condensation temperature while maintaining the evaporation temperature in the control procedure 250 of the present invention. Then, it is possible to reduce the electricity consumption of the air conditioner by decreasing ‘dT’ and increasing ‘m’ while maintaining the heat exchange amount (Q=c·m·dT) of the outdoor heat exchanger (HEX_EX) at a certain value corresponding to the size of the load.

When the conventional air conditioner is operated to some extent and the cooling load is reduced (i.e., the heat exchange requirement is reduced), the indoor unit fan (FN_IN) rotates below the maximum speed. In this case, if the heat exchange temperature difference in the evaporator is large, it is preferable to increase the evaporation temperature while maintaining the condensation temperature in the control procedure 100 of the present invention. Then, it is possible to reduce the electricity consumption of the air conditioner by reducing ‘dT’ and increasing ‘m’ while maintaining the heat exchange amount (Q=c·m·dT) of the indoor heat exchanger (HEX_IN) to the size of the load.

Here, increasing ‘m’ may be interpreted as “making the fan spin faster” or “increasing the weight of air conveyed per unit time”. Also, reducing ‘dT’ includes actually reducing the power consumption of the compressor (e.g., lowering the drive frequency of the inverter compressor), and causing the difference between the high and low pressures to be reduced without separately controlling the compressor [as a result of the control procedure 250 or the control procedure 100], resulting in lower compressor power consumption.

When the high pressure decreases while the sub-cooling degree (SC) is maintained at a constant value, the amount of heat that can be exchanged in the evaporator (HEX_E) with refrigerant of a unit weight increases. In more detail, when the high pressure is lowered while the sub-cooling degree (SC) (and the low pressure) is maintained at a certain value, that is, when the control procedure 250 is performed, a distance between the saturated liquid point and the saturated vapor point becomes further away at the high pressure (in the p-h diagram). As a result, more heat exchange can be performed in the (indoor/outdoor) heat exchanger with the same amount of refrigerant. If the amount of heat exchange required for cooling or heating has not changed, 1) the amount of refrigerant circulation per unit time (g/s) can decrease (e.g., by lowering the drive frequency of the inverter compressor) to reduce the power consumed by the compressor, and 2) a pressure difference between both ends of the compressor decreases to reduce the power consumed by the compressor.

In addition, when the low pressure increases while the super-heating degree (SH) is maintained at a constant value, the refrigerant density increases at the low pressure, resulting in an increase in the amount of refrigerant circulation per unit time (g/s), and the amount of heat that can be exchanged in the (indoor/outdoor) heat exchanger increases. If the amount of heat exchange required for cooling or heating has not changed, 1) the amount of refrigerant circulation per unit time (g/s) can decrease (e.g., by lowering the drive frequency of the inverter compressor) to reduce the power consumed by the compressor, and 2) a pressure difference between both ends of the compressor decreases to reduce the power consumed by the compressor.

Therefore, when the load is smaller than the rated value and ‘dT’ is larger than a predetermined value, the efficiency of the heat pump is improved by performing the control procedure(s) (100) or/and (250). It is natural that the desired target high pressure (HP_t) and target low pressure (LP_t) can be obtained under a plurality of conditions (e.g., an outside air temperature, a set temperature, an inside air temperature, etc.) through preceding experiments.

It is natural that the heat pump control concept of the present invention can also be applied to heating. Therefore, it is desirable to interpret the “target evaporation temperature” of the cooling mode described herein as “the heat exchange temperature of the indoor heat exchanger (HEX_IN)”. In addition, it is desirable to interpret “target condensation temperature” as “the heat exchange temperature of the outdoor heat exchanger (HEX_EX)”.

### Second Embodiment

Now, an example of a heat pump 600 adapted for the present invention will be described with reference to FIG. 6.

The heat pump 600 is configured by connecting a “circuit” including a compressor (C), a condenser (HEX_C), an expansion valve (EXV), and an evaporator (HEX_E) through a closed refrigerant line. In addition, a refrigerant storage tank (RS1) is installed in parallel with the expansion valve (EXV). Between the inlet of the expansion valve (EXV) and the inlet of the tank (RS1), a recovery valve (vvd) for recovering the refrigerant from the “circuit” is installed. Also, between the outlet of the expansion valve (EXV) and the outlet of the tank (RS1), a charging valve (vvc) for charging the refrigerant to the “circuit” is installed. Hereinafter, the refrigerant storage tank (RS1), the recovery valve (vvd), and the charging valve (vvc) will be collectively referred to as “refrigerant (charging) amount adjusting means (RAAM)”.

Hereinafter, an example of charging the refrigerant when the heat pump 600 is installed will be described. First, after a pipe of the heat pump 600 is installed, the valves (EXV) (vvd) (vvc) are opened, and the inside of the “circuit” and the refrigerant storage tank (RS1) is vacuumed by using an external vacuum pump. Then, the recovery valve (vvd) and the charging valve (vvc) are completely closed. An external refrigerant cylinder outside the heat pump 600 is connected to the “circuit”, and the compressor (C) is operated. When a value of the external refrigerant cylinder is opened, the refrigerant is charged from the external refrigerant cylinder to the heat pump 600. When a designed amount of refrigerant is charged, the external refrigerant cylinder valve is completely closed.

Hereinafter, the second control (2) for recovering the refrigerant from the “circuit” of the heat pump 600 and storing it in the refrigerant storage tank (RS1) will be described. When the refrigerant recovery valve (vvd) is opened, the condensed refrigerant is recovered, while expanded, from the “circuit” to the storage tank (RS1) because the high pressure in the “circuit” is high and the inside of the storage tank (RS1) is vacuum. When a certain amount of refrigerant is recovered to the storage tank (RS1), the refrigerant may no longer be recovered (because the high pressure and the pressure inside the storage tank become equal). In this case, by slightly opening the refrigerant charging valve (vvc) connected to the low pressure to discharge the expanded refrigerant inside the storage tank (RS1), the recovery of the condensed refrigerant continues because of a lowered internal pressure of the storage tank (RS1).

Hereinafter, the first control (1) for charging the refrigerant in the “circuit” of the heat pump 600 will be described. When the charging valve (vvc) is opened in a state that the refrigerant valve (vvd) is closed, the refrigerant inside the refrigerant storage tank (RS1) is moved by the suction force of the compressor and is charged to the “circuit”. Finally, the refrigerant is charged into the “circuit” until the pressure in the low pressure line and the internal pressure of the refrigerant storage tank (RS1) become equal.

The description of the third control (3) and the fourth control (4) is omitted because it has been made above in the description of elemental technologies of the present invention. With the above description, the first control (1) to the fourth control (4), which are the elemental technologies of the present invention, can be performed in the heat pump 600.

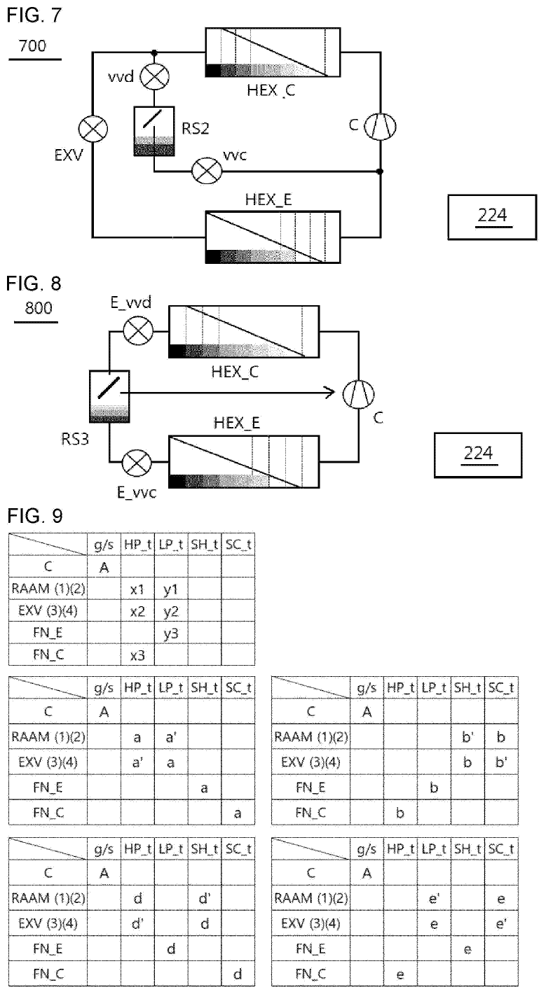

A heat pump 700 of FIG. 7 shows a case where the refrigerant charging valve (vvc) is installed between a storage tank (RS2) and the inlet of the compressor (C).

A heat pump 800 of FIG. 8 is obtained by removing the expansion valve (EXV) from the heat pump 600 of FIG. 6, changing the refrigerant storage tank (RS1) to a storage tank (RS3) capable of separating gas and liquid, and allowing the gas in the gas-liquid separator (RS3) to be injected (a broader term is “supplied”) into the compressor (C). In this case, the expansion valve (EXV) function is performed by simultaneously increasing or decreasing the opening degrees of the recovery valve (E_vvd) and the charging valve (E_vvc). Charging and recovery of the refrigerant can be performed on the same principle as the heat pump 600, so a detailed description thereof will be omitted.

In FIGS. 6 to 8, the refrigerant (charging) amount adjusting means (RAAM) should be interpreted as being installed in parallel with the expansion valve (EXV).

### Third Embodiment

Now, an example of a method for controlling a cooling mode in the heat pump 600 adapted for the present invention will be described with reference to FIG. 6. The circuit configuration of the heat pump 600 has been described above and thus will be omitted. In the present invention, a controller 224 preferably includes the following first to seventh roles.

1) Variable Capacity Compressor Control: The controller 224 controls the compressor (C) to compress the set amount of refrigerant per unit time (g/s). The compression amount (g/s) can be calculated by referring to the cooling load. In case of the inverter compressor (C), it operates at a frequency set in response to the load. If the low pressure and super-heating degree (SC) are kept constant, the density of the refrigerant is constant under that condition, and thus the amount of refrigerant per unit time (g/s) compressed by the compressor (C) will be calculated for each driving frequency (hereinafter, “refrigerant compression amount control per unit time”). It is natural that a compressor having a variable compression stroke distance can be used in the present invention.

2) Condenser Fan Speed Control: The controller 224 controls the speed of the condenser fan (FN_C) so that the sub-cooling degree (SC) of the refrigerant measured at the outlet of the condenser (HEX_C) becomes the target sub-cooling degree (SC_t) (hereinafter, “sub-cooling degree control with condenser fan”).

3) Evaporator Fan Speed Control: The controller 224 controls the speed of the evaporator fan (FN_E) so that the super-heating degree (SH) of the refrigerant measured at the outlet of the evaporator (HEX_E) becomes the target super-heating degree (SH_t) (hereinafter, “super-heating degree control with evaporator fan”).

4) Expansion Valve Opening Control: When the expansion valve (EEV) is opened more than a current state, the high pressure rises and the low pressure falls. Conversely, when the expansion valve (EEV) is closed more than a current state, the high pressure rises and the low pressure falls. In the present invention, the controller 224 controls the expansion valve (EXV) so that one of the two pressures becomes the target pressure. Hereinafter, when as the first-priority achievement goal the controller 224 controls the low pressure with the expansion valve, it is referred to as “low pressure control with the expansion valve”. In addition, when controlling the high pressure is the first-priority achievement goal, it is referred to as “high pressure control with the expansion valve”. To this end, the expansion valve EXV is preferably an electronic expansion valve (EEV).

5) Refrigerant (Charging) Amount Adjusting Means (RAAM) Control: When the refrigerant is charged into the circuit, both high and low pressures rise, and when recovered, both fall. In the present invention, the controller 224 controls the refrigerant (charging) amount adjusting means so that one of two pressures becomes the target pressure. Hereinafter, when as the first-priority achievement goal the controller 224 controls the high pressure with the refrigerant (charging) amount adjusting means, it is referred to as “high pressure control with the refrigerant (charging) amount adjusting means (RAAM)”. In addition, when controlling the low pressure is the first-priority achievement goal, it is referred to as “low pressure control with the refrigerant (charging) amount adjusting means (RAAM)”.

6) Target Condensation Temperature Setting: It is desirable that the controller 224 sets the target condensation temperature (HP_t) higher than the outside air temperature by a predetermined value (c1) by referring to the outside air temperature (Ta) as shown in Equation 1.

Tc=Ta+c1 (Equation 1)

Example) c1=10.0, Tc=Ta+10.0 regardless of the load size

It is also desirable to set by referring to the outside air temperature and the load size as shown in Equation 2.

Tc=Ta+c1+c2×Qc/Qc_max (Equation 2)

Example) c1=10.0, c2=1.0, rated condensing load (Qc_max)=10.0 kW,

If condensation load (Qc)=2 kW, Tc=Ta+10.2° C.,

If condensation load (Qc)=kW, Tc=Ta+10.4° C.

7) Target Evaporation Temperature Setting: It is desirable that the controller 224 sets the target evaporation temperature to be lower than the inside air temperature by a predetermined value (el) by referring to the inside air temperature (Tin) as shown in Equation 3.

Te=Tin−e1 (Equation 3)

Example) e1=15.0, Te=Tin−15.0 regardless of the load size

It is also desirable to set by referring to the inside air temperature (Tin) and the load size as shown in Equation 4.

Te=Tin−(e1+e2×Qe/Qe max) (Equation 4)

Example) e1=10.0, e2=10.0, rated evaporation load (Qe_max)=10.0 kW

If evaporation load (Qe)=3 kW, Te =Tin−13.0° C.

If evaporation load (Qe)=9 kW, Te =Tin−19.0° C.

Meanwhile, the target condensation temperature (HP_t) and the target evaporation temperature (LP_t) can be obtained through a plurality of preceding experiments in various environments (e.g., an outside temperature, an inside temperature, a humidity, a set temperature, etc.), and it is natural that the controller 224 can use the obtained values. In addition, it is natural that the controller can set the target values (HP_t) (LP_t) at any time or at a predetermined control period according to a change in load.

Hereinafter, with reference to the control procedure 100 of FIG. 5, a preferred control procedure in case of increasing the low pressure (maintaining the high pressure) will be described. Because it is intended to increase the low pressure than the current state [initial state L0], the controller 224 sets the target low pressure (LP_t) to be higher than the current state (LP_0). Then, because the current low pressure (LP_0) and the target low pressure (LP_t) are different, the “low pressure control with the expansion valve” is operated so as to make the low pressure equal to the target value (LP_t) and thereby the fourth control (4) of further opening the expansion valve than the current state is performed. With the fourth control (4), the high pressure falls and the low pressure rises, so that the state is changed from L0 to L1. The high pressure is out of the target value (HP_t) by the fourth control (4). Therefore, the “high pressure control with the refrigerant (charging) amount adjusting means (RAAM)” is operated so as to maintain the target high pressure (HP_t) and thereby the first control (1) of charging the refrigerant in the circuit is performed. With the first control (1), both the high and low pressures rise, so that the state is changed from L1 to L2. As a result, the high pressure is maintained at the same value as the initial state LO, and the low pressure becomes closer to the target low pressure (LP_t). The state L3 and the state L4 show results obtained by sequentially repeating the fourth control (4) and the first control (1) once more.

Hereinafter, with reference to the control procedure 150 of FIG. 5, a preferred control procedure in case of lowering the low pressure (maintaining the high pressure) will be described. Because it is intended to lower the low pressure than the current state [initial state L5], the controller 224 sets the target low pressure (LP_t) to be lower than the current state (LP_0). Then, because the current low pressure (LP_0) and the target low pressure (LP_t) are different, the “low pressure control with the expansion valve” is operated so as to make the low pressure equal to the target value (LP_t) and thereby the third control (3) of further closing the expansion valve than the current state is performed. With the third control (3), the high pressure rises and the low pressure falls, so that the state is changed from L5 to L6. The high pressure is out of the target value (HP_t) by the third control (3). Therefore, the “high pressure control with the refrigerant (charging) amount adjusting means (RAAM)” is operated so as to maintain the target high pressure (HP_t) and thereby the second control (2) of recovering the refrigerant from the circuit is performed. With the second control (2), both the high and low pressures fall, so that the state is changed from L6 to L7. As a result, the high pressure is maintained at the same value as the initial state L5, and the low pressure becomes closer to the target low pressure (LP_t). The state L8 and the state L9 show results obtained by sequentially repeating the third control (3) and the second control (2) once more.

The control procedures 200 and 250 are similar to the above-described control procedures 100 and 150, so that detailed descriptions thereof are omitted.

Hereinafter, with reference to the control procedure 101 of FIG. 4, a preferred control procedure in case of increasing the low pressure (maintaining the high pressure) will be described. Because it is intended to increase the low pressure than the current state [initial state L0a], the controller 224 sets the target low pressure (LP_t) to be higher than the current state (LP_0). Then, because the current low pressure (LP_0) and the target low pressure (LP_t) are different, the “low pressure control with the refrigerant (charging) amount adjusting means (RAAM)” is operated so as to make the low pressure equal to the target value (LP_t) and thereby the first control (1) of charging the refrigerant is performed. With the first control (1), both the high and low pressures rise, so that the state is changed from L0a to L1a. The high pressure is out of the target value (HP_t) by the first control (1). Therefore, the “high pressure control with the expansion valve” is operated so as to maintain the target high pressure (HP_t) and thereby the fourth control (4) of further opening the expansion valve is performed. With the fourth control (4), the high pressure falls and the low pressure rises, so that the state is changed from L1a to L2a. As a result, the high pressure is maintained at the same value as the initial state L0a, and the low pressure becomes closer to the target low pressure (LP_t). The state L3a and the state L4a show results obtained by sequentially repeating the fourth control (4) and the first control (1) once more.

In a broad sense, the control procedure 100 described in this embodiment should be interpreted as including the control procedure 101. Specifically, the control procedures 100 and 101 both use the first control (1) for charging the refrigerant and the fourth control (4) for further closing the expansion valve. With control for charging the refrigerant, the control procedure 100 adjusts the low pressure, and the control procedure 101 adjusts the high pressure. In addition, with control for further closing the expansion valve, the control procedure 100 adjusts the low pressure, and the control procedure 101 adjusts the high pressure. In summary, the same result can be obtained even if the order of the first control (1) and the fourth control (4) is changed. To this end, the goals of the first control (1) and the fourth control (4) should be interchanged.

### Fourth Embodiment

With reference to FIG. 9, preferred roles of the controller 224 for main components in the cooling mode of the heat pump of the present invention will be described. The control procedures 100 to 250 of the present invention may be implemented as case (a) in FIG. 9. In more detail, the controller 224 may perform the following first to seventh roles to execute the control procedures 100 to 250.

1) Target Condensation Temperature (HP_t) Setting: The controller 224 performs, by referring to the outside temperature, the load, etc., a role of setting the target temperature (target condensation temperature) at which the refrigerant boils inside the outdoor heat exchanger (condenser). When the time passes from morning to lunch and the outside temperature and load gradually rise, the target condensation temperature (HP_t) may be gradually set higher than the current state (HP).

2) Target Evaporation Temperature (LP_t) Setting: The controller 224 performs, by referring to the inside temperature, the set temperature, etc., a role of setting the target temperature (target evaporation temperature) at which the refrigerant boils inside the indoor heat exchanger (evaporator). When the difference between the inside temperature and the set temperature is small, and when the current evaporator fan (FN_E) speed is less than the design rating, the target evaporation temperature (LP_t) may be set higher than the current state.

3) Refrigerant Compression Amount Control: The controller 224 performs a role of controlling the variable capacity compressor (C) to compress a predetermined amount of refrigerant per unit time (g/s). For example, if the low pressure and the super-heating degree (SC) are maintained at a constant value, the density of the refrigerant is constant under that condition, and thus the amount of refrigerant per unit time (g/s) compressed by the compressor (C) will be calculated for each compressor driving frequency [(A) in FIG. 9].

4) Super-Heating Degree Control: The controller 224 performs a role of controlling the speed of the evaporator fan (FN_E) so that the super-heating degree (SH) becomes the target super-heating degree (SH_t) [intersection (a) between (SH_t) and (FN_E) in FIG. 9].

5) Sub-Cooling Degree Control: The controller 224 controls the speed of the condenser fan (FN_C) so that the sub-cooling degree (SC) becomes the target sub-cooling degree (SC_t) [intersection (a) between (SC_t) and (FN_C) in FIG. 9].

6) Low Pressure Control: The controller 224 performs a role of controlling the expansion valve (EXV) so that the low pressure (LP) becomes the target pressure (LP_t). Specifically, when the expansion valve is adjusted, the high and low pressures are changed together. In this case, the controller performs a role of “low pressure control with the expansion valve” that controls the low pressure to become the target value [intersection (a) between (LP_t) and (EXV) in FIG. 9].

7) High Pressure Control: The controller 224 performs a role of controlling the refrigerant (charging) amount adjusting means (RAAM) so that the high pressure (HP) becomes the target pressure (HP_t). When refrigerant is charged or recovered, the high and low pressures rise or fall simultaneously. In this case, the controller performs a role of “high pressure control with the refrigerant (charging) amount adjusting means (RAAM)” that controls the high pressure to become the target value [intersection (a) between (HP_t) and (RAAM) in FIG. 9].

There is no order specially required for the controller 224 to perform the first to seventh roles. As an extreme example, one controller may be assigned to each component, and each controller having an independent goal may perform control to achieve that goal.

Meanwhile, in order to perform the control procedures 100 to 250 of FIG. 5, the current pressure and the target pressure should be different. So, the first or second role of setting the target pressure has to be executed preferentially. For example, the control procedure 100 sets the target evaporation temperature (LP_t) higher than the current state (the second role). Then, because the low pressure is different from the target value, the “low pressure control with the expansion valve” is automatically operated (the sixth role). The high pressure is changed with the sixth role, and the “high pressure control with the refrigerant (charging) amount adjusting means (RAAM)” is automatically operated (the seventh role).

The control procedure 150 is implemented with the second, sixth and seventh roles, like the control procedure 100. In the second role, only setting the target evaporation temperature (LP_t) lower than the current state is different from the control procedure 100.

In the control procedures 200 and 250, the first role of setting the target condensation temperature is performed first. Then, because the high pressure becomes different from the target value, the “high pressure control with the refrigerant (charging) amount adjusting means (RAAM)” is automatically operated (the seventh role). The low pressure is changed with the seventh role, and the “low pressure control with the expansion valve” is automatically operated (the sixth role).

Until now, it has been described that when the target high pressure or the target low pressure is set, the low pressure control (sixth role) and the high pressure control (seventh role) are automatically operated and thereby the control procedures 100 to 250 of the present invention are performed.

In the first and third embodiments, it has been described that the control procedures 101 and 101 in which the control targets of the expansion valve (EXV) and the refrigerant (charging) amount adjusting means (RAAM) are changed have the same result. When this is applied to case (a) of FIG. 9, it becomes case (a′). Specifically, when the controller adjusts the low pressure with the refrigerant (charging) amount adjusting means (RAAM) [intersection (a′) between (LP_t) and (RAAM) in FIG. 9] and adjusts the high pressure with the expansion valve [intersection (a′) between (HP_t) and (EXV) in FIG. 9, hereinafter the phrase “in FIG. 9” is omitted], it becomes case (a′).

In cases (b) to (e) of FIG. 9 described below, the first to third roles are the same as those of the case (a), and the fourth to seventh roles are different.

Cases (b) and (b′) of FIG. 9 show that all pressures (high pressure, low pressure) are controlled by the fan speed, and super-heating and sub-cooling degrees are controlled by the expansion valve and the refrigerant (charging) amount adjusting means. In more detail, the high pressure (HP) is adjusted by controlling the speed of the condenser fan (FN_C) [intersection (b) between (HP_t) and (FN_C)], and the low pressure (LP) is adjusted by controlling the speed of the evaporator fan (FN_E) [intersection (b) between (LP_t) and (FN_E)]. Also, when the super-heating degree (SH) is adjusted with the expansion valve

(EXV) [intersection (b) between (SH_t) and (EXV)], and when the sub-cooling degree (SC) is adjusted with the refrigerant (charging) amount adjusting means (RAAM) [intersection (b) between (SC_t) and (RAAM)], it becomes the case (b).

In the first and third embodiments, it has been described that the control procedures 101 and 101 in which the control targets of the expansion valve (EXV) and the refrigerant (charging) amount adjusting means (RAAM) are changed have the same result. When this is applied to case (b) of FIG. 9, it becomes case (b′). Specifically, if the control targets of the expansion valve (EXV) and the refrigerant (charging) amount adjusting means (RAAM) are interchanged in the case (b), the case (b′) is obtained. When the super-heating degree (SH) is adjusted with the refrigerant (charging) amount adjusting means (RAAM) [intersection (b′) between (SH_t) and (RAAM)], and when the sub-cooling degree (SC) is adjusted with the expansion valve (EXV) [intersection (b′) between (SC_t) and (EXV)], it becomes the case (b′).

In the cases (a), (a′), (b) and (b′), the fans (evaporator fan, condenser fan) all control the pressure (high pressure, low pressure), or all adjusts the temperature (super-heating degree, sub-cooling degree).

Hereinafter, when the controller 224 performs a role of controlling the refrigerant (charging) amount adjusting means

(RAAM) so that the high pressure (HP) becomes the target high pressure (HP_t), it is referred to as ‘x1’, when the controller 224 performs a role of controlling the expansion valve (EXV), it is referred to as ‘x2’, and when the controller 224 performs a role of controlling the speed of the condenser fan (FN_C), it is referred to as ‘x3’.

In addition, when the controller 224 performs a role of controlling the refrigerant (charging) amount adjusting means (RAAM) so that the low pressure (LP) becomes the target low pressure (LP_t), it is referred to as ‘y1’, when the controller 224 performs a role of controlling the expansion valve (EXV), it is referred to as ‘y2’, and when the controller 224 performs a role of controlling the speed of the evaporator fan (FN_E), it is referred to as ‘y3’.

Upon combining the x1 to x3 for controlling the high pressure and the y1 to y3 for controlling the low pressure, the high and low pressures can be adjusted by the following seven combinations, that is, (x1, y2), (x1, y3), (x2, y1), (x2, y3), (x3, y1), (x3, y2), and (x3, y3). Here, it can be seen that case (a) is a combination of (x1, y2), the case (a′) is a combination of (x2, y1), and the case (b) is a combination of (x3, y3).

Meanwhile, in cases (d) and (e) of FIG. 9, one of two fans (evaporator fan, condenser fan) controls the pressure, and the other controls the temperature of either super-heating degree or sub-cooling degree.

Specifically, in the case (d) which is a combination of (x1, y3), the low pressure (y3) is adjusted by controlling the speed of the evaporator fan (FN_E) [intersection (d) between (LP_t) and (FN_E)], and the super-heating degree (SH) is adjusted by controlling the expansion valve (EXV) [intersection (d) between (SH_t) and (EXV)]. Also, the high pressure (HP) is adjusted by controlling the refrigerant (charging) amount adjusting means (RAAM) [intersection (d) between (HP_t) and (RAAM)]. Then, by controlling the speed of the condenser fan (FN_C), the sub-cooling degree (SC) is adjusted [intersection (d) between (SC_t) and (FN_C)].

In the case (d), if the control targets of the expansion valve (EXV) and the refrigerant (charging) amount adjusting means (RAAM) are exchanged, it becomes the case (d′). In detail, the high pressure (HP) is adjusted by controlling the expansion valve (EXV) [intersection (d′) between (HP_t) and (EXV)], and the super-heating degree (SH) is adjusted by controlling the refrigerant (charging) amount adjusting means (RAAM) [intersection (d′) between (SH_t) and (RAAM)]. For example, if the super-heating degree is higher than the target, the refrigerant is charged by the above means to achieve the target super-heating degree (SH_t). Here, it can be seen that the case (d′) is a combination of (x2, y3).

In the case (e) which is a combination of (x3, y2), the high pressure (HP) is adjusted by controlling the speed of the condenser fan (FN_C) [intersection (e) between (HP_t) and (FN_C)], and the super-heating degree (SH) is adjusted by controlling the speed of the evaporator fan (FN_E) [intersection (e) between (SH_t) and (FN_E)]. In addition, the low pressure (LP) is adjusted by controlling the expansion valve (EXV) [intersection (e) between (LP_t) and (EXV)], and the sub-cooling degree (SC) is adjusted by controlling the refrigerant (charging) amount adjusting means (RAAM) [intersection (e) between (SC_t) and (RAAM)].

If the control targets of the expansion valve (EXV) and the refrigerant (charging) amount adjusting means (RAAM) are exchanged in the case (e), it becomes the case (e′). Specifically, the sub-cooling degree (SC) is adjusted by controlling the expansion valve (EXV) [intersection (e′) between (SC_t) and (EXV)], and the low pressure (LP) is adjusted by controlling the refrigerant (charging) amount adjusting means (RAAM) [intersection (e′) between (LP_t) and (RAAM)]. Here, it can be seen that the case (e′) is a combination of (x3, y1).

### Industrial Effect

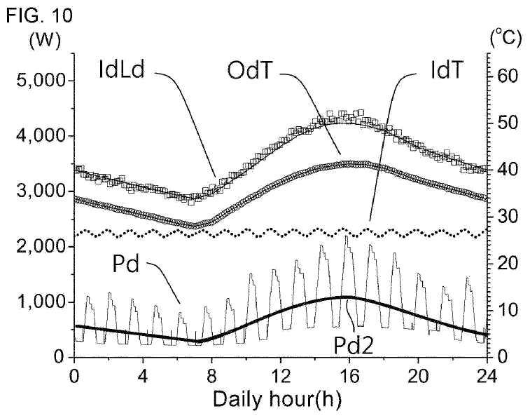

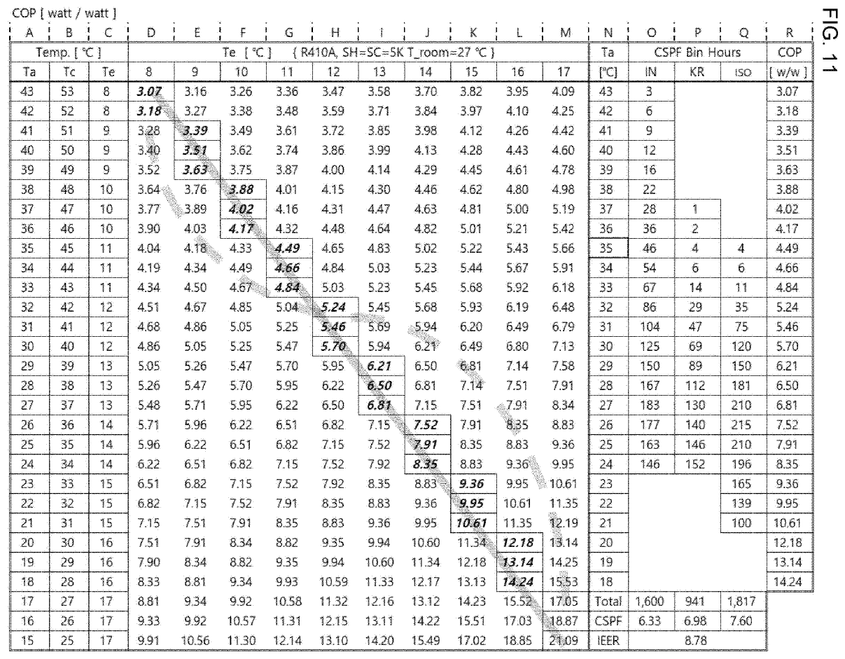

Now, the advantages of the present invention will be briefly described with reference to FIG. 10. FIG. 10 is cited in the prior art (non-patent document) mentioned in the present description, and shows a measurement result while the inverter air conditioner is operated for 24 hours.

In FIG. 10, the indoor load (IdLd) is indicated by a square, the outside temperature (OdT) is indicated by a circle, and the inside temperature (IdT) is indicated by a dot. In addition, the power consumption (Pd) is indicated by a solid line. The inside temperature (IdT) is properly controlled between about 26° C. and 28° C. As the time passed from 0 o'clock to 24 o'clock, the outside temperature (OdT) and the indoor load (IdLd) gradually changed, and their shapes are similar.

The measured power consumption (Pd) repeats fluctuations every about an hour and a half. In some cases, the fluctuation range is about 1.5 kW. This is because the conventional technology (e.g., US 2009/00137001 and application number KR 10-2016-0072934) controls the low pressure with the compressor that consumes the most electricity in the heat pump. If the target pressure is achieved with any other component (e.g., the expansion valves), or means (e.g., the refrigerant charging amount adjusting means), having small electricity consumption, the power consumption fluctuation range may be stabilized within several watts to tens of watts. As a result, the power consumption of the heat pump will gradually change to a form (Pd2) similar to the indoor load (IdLd).

In this case, it is desirable that the compressor is controlled to suit the heat exchange demand (IdLd). For example, if the compressor inlet pressure and the super-heating degree are controlled to a certain value, the refrigerant density at the compressor inlet is also fixed to a certain value. Therefore, in order to compress the amount of refrigerant per unit time (g/s) suitable for the heat exchange demand (IdLd), the frequency of the inverter compressor may be controlled. As shown in FIG. 10, if the indoor load (IdLd) changes gradually, the frequency of the inverter compressor will also change gradually. In addition, the power consumption (Pd2) will gradually change in a form similar to the indoor load.

The present invention can eliminate power fluctuations of several kW that appear at approximately one-and-a-half hours intervals in the conventional heat pump power consumption (Pd), so that it is possible to lower the reserve power of the power plant. In addition, a control program is simplified because the drive frequency of the compressor actively generating the pressure changes gradually and the high and low pressures will gradually change accordingly. As a result, a higher level of optimization is possible than before, and energy efficiency is expected to be improved.

### Fifth Embodiment

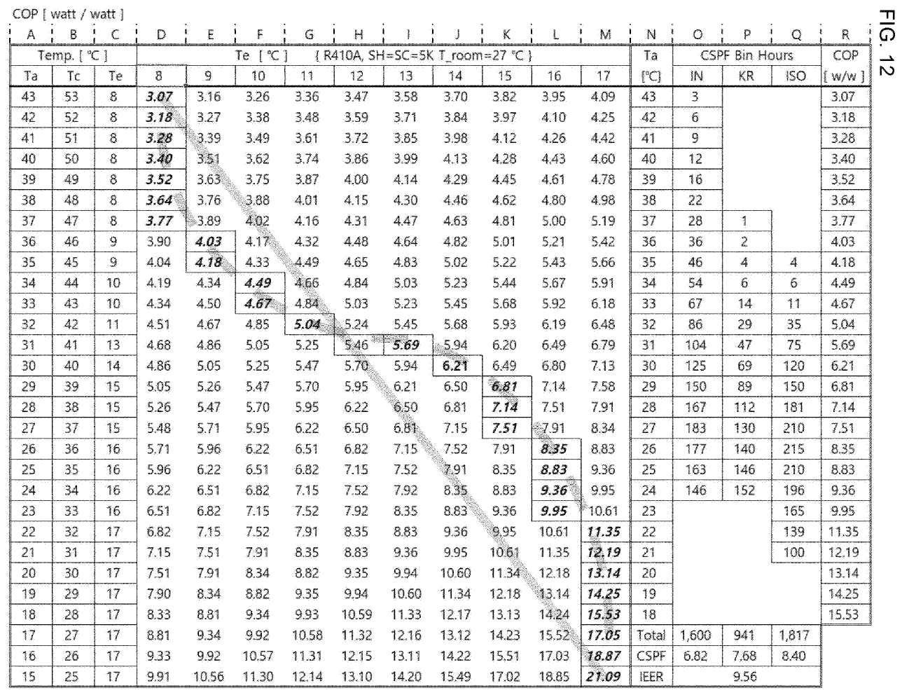

Hereinafter, an example of setting the target condensation temperature (HP_t) and the target evaporation temperature (LP_t) in the cooling mode control of the heat pump adapted for the present invention will be described. The left side of FIG. 11 is a table showing the coefficient of performance (hereinafter “COP”) for a combination of the condensation temperature (Tc) and the evaporation temperature (Te). In addition, the right side of FIG. 11 shows an example of the cooling seasonal performance factor (hereinafter, “”) calculated using the COP.

In the COP table of FIG. 11, the column A records the outside air temperature (Ta) at intervals of 1° C. from a high value to a low value. The column B records the target value of the condensation temperature (Tc) at the outside air temperature (Ta). The target condensation temperature (HP_t) is set to be 10° C. higher than the outside air temperature (Ta) by using Equation 1. The column D represents the COP calculated using the value of the column B as the condensation temperature in case that the evaporation temperature (Te) is set to 8° C. The columns E to M represent the COPs calculated in the same manner as in the column D. In the COP calculation, the evaporation temperature (Te) is a value between 8° C. and 17° C., and the condensation temperature (Tc) is the value of the column B.

Hereinafter, a method of selecting the target evaporation temperature (LP_t) will be described. In the COP table of FIG. 11, a straight line is drawn to connect a point (hereinafter “first point”) where the condensation temperature (Tc) is the highest (53° C.) and the evaporation temperature is the lowest (8T), and a point (hereinafter, “second point”) where the condensation temperature (Tc) is the lowest (25° C.) and the evaporation temperature is the highest (17° C.). Then, the COP values (indicated by italic numbers) under the straight line are recorded in the column R and used in calculating the CSPF. In addition, the values of the evaporation temperature (Te) applied to the COP values (indicated by italic numbers) under the straight line (indicated by the inclined number) are recorded in the column C. The evaporation temperature (Te) in the column C is the target evaporation temperature (LP_t) (hereinafter, “evaporation temperature linear correction”).

Hereinafter, a method of calculating the CSPF will be described. In FIG. 11, the CSPF calculation uses the columns N to R. The column N records the outside temperature (Ta). The column R records the COP (indicated by italic numbers under the straight line in FIG. 11) of the heat pump at the outside temperature (Ta). The columns O to Q record the operating hours of the air conditioner for each region's outdoor air temperature. The column O is India, the column P is Korea, and the column Q is ISO 16358 value. If the CSPF is calculated using the air conditioner operating time in the above columns, India is 6.33, Korea is 6.98, and ISO 16358 is 7.60.

In the above method, the target evaporation temperature is set to increase as the outside temperature decreases. This is generally possible because the lower the outside temperature, the lower the cooling load. In this case, the heat exchange amount is calculated as Q=c·m·dT so that ‘Q’ satisfies the load. Specifically, by lowering ‘dT’, the compressor power consumption, which consumes the most electricity in the heat pump, is reduced, and by increasing ‘m’, ‘Q’ becomes the same as before lowering ‘dT’. To lower ‘dT’, the evaporation temperature of the refrigerant is increased (that is, by increasing the low pressure) and thereby the temperature difference with the air flowing into the heat exchanger is reduced.

Hereinafter, a method of further improving the CSPF will be described. In a COP table of FIG. 12, near the second point (i.e., evaporation temperature 17° C., condensation temperature 25° C.˜31° C.), a COP having a higher value than a COP under the straight line connecting two points is selected as the target COP. In addition, the evaporation temperature (Te) at which the target COP is calculated is set as the target evaporation temperature (LP_t). The target COP is used for CSPF calculation. For example, when the outside temperature (Ta) is 28° C., the COP under the straight line is 6.50, and selected is 7.14 (under the curve) among the COP values higher than the above 6.50. Then, the evaporation temperature (Te) 15° C. at which the COP is calculated is selected as the target evaporation temperature (LP_t). Because the COP selected from the curve near the second point is higher than the COP selected from the straight line, and the operating time of the air conditioner is relatively large, the CSPF is greatly improved than before (hereinafter, “evaporation temperature curve correction for the lower outside air”).

When an example of the COPs selected according to the above description is visually expressed, it can be illustrated as a curve indicated by a dotted line in FIG. 12. In FIG. 12, when the CSPF is calculated using the COP values (indicated by italic numbers) under the curve, it is improved compared to the case of using the COP values under the straight line. In other words, the CSPF is improved from 6.33 to 6.82 in India, from 6.98 to 7.68 in Korea, and from 7.60 to 8.40 in ISO 16358. In this case, the “evaporation temperature curve correction for the lower outside air” appears on the right side of the straight line (connecting the first and second points) in FIG. 12.

In this embodiment, the CSPF of some regions has been calculated using a set of target COP values indicated in the column R. In actual implementation, the CSPF can be calculated using the target condensation temperature (HP_t) and target evaporation temperature (LP_t) optimized for each region. In other words, the target evaporation temperature may be selected using the maximum and minimum temperatures of the outside air used to calculate the CSPF for each region as the first and second points. Therefore, the minimum and maximum values of the condensing temperature and evaporation temperature may be different for each region.

On the other hand, it is natural that the concept of this embodiment can be applied to the integrated energy efficiency radio (IEER) calculated by obtaining the coefficient of performance for each load at several loads (e.g., 100%, 75%, 50%, and 25% loads) and assigning a weight considering the operating time for each load.

The preferred embodiments of the present invention have been described hereinbefore.

In the present invention, the case of operating the heat pump in the cooling mode has been described in detail, but it is natural that the concept of the present invention can be used even in the heating mode. In addition, although it has been described as one compressor, one outdoor heat exchanger (HEX_EX), and one indoor heat exchanger (HEX_IN), it is apparent to those skilled in the art that the present invention can be implemented with a plurality of heat exchangers and a plurality of compressors. It is also natural that the concept and control method of the invention can be applied to the heat pump circuit illustrated in the prior documents.

In this description, heat exchange with air has been described, but it is apparent to those skilled in the art that heat exchange with liquid is also applicable. Therefore, in the present invention, air should be interpreted as a “fluid” including water. In addition, it is natural that the fan for supplying the fluid to the heat exchanger includes a pump for flowing the liquid to the heat exchanger.

While the present invention has been particularly described and shown with reference to exemplary embodiments thereof and drawings, but this is only provided to help a better understanding of the present invention. The present invention is not limited to such embodiments, and various modifications and variations are possible from the descriptions as being apparent to those skilled in the art.

### INDUSTRIAL APPLICABILITY

The heat pump of the present invention can minimize the difference between high and low pressures while maintaining the amount of heat exchange, thereby improving energy efficiency and thus having very high industrial applicability. Specifically, the compressor that consumes the most electricity in the heat pump consumes more electricity even if it is operated at the same frequency as the difference between the compressor inlet and outlet pressures increases. According to the present invention, the heat pump having improved efficiency is provided by setting and controlling the inlet and outlet pressures of the compressor as the first-priority achievement goal, thus having very high industrial applicability.

In addition, the present invention can eliminate the power fluctuations of several kW that occur at approximately one-and-a-half hours intervals in the conventional heat pump, so that it is possible to reduce the reserve power of the power plant. In addition, a control program is simplified because the drive frequency of the compressor actively generating the pressure changes gradually and the high and low pressures will gradually change accordingly. As a result, a higher level of optimization is possible than before, so that the heat pump having improved efficiency is provided, and thus industrial applicability is very high.

1-5. (canceled)

6. A heat pump configured by connecting a circuit including a variable capacity compressor (C), a condenser (HEX_C), an expansion valve (EXV), and an evaporator (HEX_E) through a closed refrigerant line, and comprising a condenser fan (FN_C), an evaporator fan (FN_E), a refrigerant amount adjusting means (RAAM) installed in parallel with the expansion valve (EXV), and a controller,
wherein the refrigerant amount adjusting means (RAAM) includes a refrigerant storage space (RS) for storing refrigerant, a recovery valve (vvd) for recovering the refrigerant from the circuit to the refrigerant storage space (RS), and a charging valve (vvc) for charging the refrigerant from the refrigerant storage space (RS) to the circuit, the recovery valve (vvd) being connected to an outlet of the condenser (HEX_C), and the charging valve (vvc) being connected to a low pressure; and
wherein roles of the controller include
1 1) setting a target pressure of an outdoor heat exchanger (HEX_EX), wherein the target pressure is set either at a high pressure (HP_t) in a cooling mode or at a low pressure (LP_t) in a heating mode,
2) setting a target pressure of an indoor heat exchanger (HEX_IN), wherein the target pressure is set either at a high pressure (HP_t) in a cooling mode or at a low pressure (LP_t) in a heating mode,
3) setting a target sub-cooling degree (SC_t) and a target super-heating degree (SH_t),
4) controlling both of the fans to either adjust temperature or adjust pressure,
4a) in case that both of the fans adjust temperature, providing a control value to the evaporator fan (FN_E) so that a super-heating degree becomes the target super-heating degree (SH_t), providing a control value to the condenser fan (FN_C) so that a sub-cooling degree becomes the target sub-cooling degree (SC_t), providing a control value to one of the expansion valve (EXV) and the refrigerant amount adjusting means (RAAM) so that a high pressure (HP) becomes the target high pressure (HP_t), and providing a control value to other one so that a low pressure becomes the target low pressure (cases (a) and (a′)),
4b) in case that both of the fans adjust pressure, providing a control value to the condenser fan (FN_C) so that a high pressure (HP) becomes the target high pressure (HP_T), providing a control value to the evaporator fan (FN_E) so that a low pressure becomes the target low pressure (LP_t), providing a control value to one of the expansion valve (EXV) and the refrigerant amount adjusting means (RAAM) so that a sub-cooling degree becomes the target sub-cooling degree (SC_t), and providing a control value to other one so that a super-heating degree becomes the target super-heating degree (cases (b) and (b′)), and
5) providing a control value to the compressor (C) so that a predetermined refrigerant per unit time (gram/sec) is compressed with reference to load.

7. A heat pump configured by connecting a circuit including a variable capacity compressor (C), a condenser (HEX_C), an expansion valve (EXV), and an evaporator (HEX_E) through a closed refrigerant line, and comprising a condenser fan (FN_C), an evaporator fan (FN_E), a refrigerant amount adjusting means (RAAM) installed in parallel with the expansion valve (EXV), and a controller,
wherein the refrigerant amount adjusting means (RAAM) includes a refrigerant storage space (RS) for storing refrigerant, a recovery valve (vvd) for recovering the refrigerant from the circuit to the refrigerant storage space (RS), and a charging valve (vvc) for charging the refrigerant from the refrigerant storage space (RS) to the circuit, the recovery valve (vvd) being connected to an outlet of the condenser (HEX_C), and the charging valve (vvc) being connected to a low pressure; and
wherein roles of the controller 224 include
1) setting a target pressure of an outdoor heat exchanger (HEX_EX), wherein the target pressure is set either at a high pressure (HP 0 in a cooling mode or at a low pressure (LP_t) in a heating mode,
2) setting a target pressure of an indoor heat exchanger (HEX_IN), wherein the target pressure is set either at a high pressure (HP_T) in a cooling mode or at a low pressure (LP_t) in a heating mode,
3) setting a target sub-cooling degree (SC_t) and a target super-heating degree
4) controlling one of the two fans to adjust pressure and controlling other one to adjust temperature,
4a) in case of providing a control value to the evaporator fan (FN_E) so that a low pressure becomes the target low pressure (LP_t), providing a control value to the condenser fan (FN_C) so that a sub-cooling degree becomes the target sub-cooling degree (SC_t), providing a control value to one of the expansion valve (EXV) and the refrigerant (charging) amount adjusting means (RAAM) so that a high pressure becomes the target high pressure (HP_t), and providing a control value to other one so that a super-heating degree becomes the target super-heating degree (cases (d) and (d′)),
4b) in case of providing a control value to the condenser fan (FN_C) so that a high pressure becomes the target high pressure (HP_T), providing a control value to the evaporator fan (FN_E) so that a super-heating degree becomes the target super-heating degree (SH_t), providing a control value to one of the expansion valve (EXV) and the refrigerant (charging) amount adjusting means (RAAM) so that a low pressure becomes the target low pressure (LP_t), and providing a control value to other one so that a sub-cooling degree becomes the target sub-cooling degree (cases (e) and (e′)), and
5) providing a control value to the compressor (C) so that a predetermined refrigerant per unit time (gram/sec) is compressed with reference to load.

8. The heat pump of claim 6, further comprising:
a pipe for injecting the refrigerant from the refrigerant storage space (RS) to the compressor (C).

9. The heat pump of claim 7, further comprising:
a pipe for injecting the refrigerant from the refrigerant storage space (RS) to the compressor (C).

10. The heat pump of claim 8, wherein the controller performs control of simultaneously increasing or decreasing opening degrees of the recovery valve (vvd) and the charging valve (vvc) so that the refrigerant (charging) amount adjusting means (RAAM) performs a role of the expansion valve (EXV).

11. The heat pump of claim 9, wherein the controller performs control of simultaneously increasing or decreasing opening degrees of the recovery valve (vvd) and the charging valve (vvc) so that the refrigerant (charging) amount adjusting means (RAAM) performs a role of the expansion valve (EXV).

12. A heat pump configured by connecting a circuit including a variable capacity compressor (C), a condenser (HEX_C), an expansion valve (EXV), and an evaporator (HEX_E) through a closed refrigerant line, and comprising a condenser fan (FN_C), an evaporator fan (FN_E), a refrigerant amount adjusting means (RAAM), and a controller 224,
wherein roles (cases (a)) of the controller include:
1) setting a target pressure of an outdoor heat exchanger (HEX_EX), wherein the target pressure is set either at a high pressure (HP_t) in a cooling mode or at a low pressure (LP_t) in a heating mode,
2) setting a target pressure of an indoor heat exchanger (HEX_IN), wherein the target pressure is set either at a high pressure (HP_t) in a cooling mode or at a low pressure (LP_t) in a heating mode,
3) setting a target sub-cooling degree (SC_t) and a target super-heating degree (SH_t),
4) providing a control value to the refrigerant amount adjusting means (RAAM) so that a high pressure (HP) becomes the target high pressure (HP_t),
5) providing a control value to the expansion valve (EXV) so that a low pressure becomes the target low pressure (LP_t),
6) providing a control value to the evaporator fan (FN_E) so that a super-heating degree becomes the target super-heating degree (SH_t),
7) providing a control value to the condenser fan (FN_C) so that a sub-cooling degree becomes the target sub-cooling degree (SC_t), and
8) providing a control value to the compressor (C) so that a predetermined refrigerant per unit time (gram/sec) is compressed with reference to load.
